(19) United States
(12) Patent Application Publication
(10) Pub. No.: US 2024/0128923 A1
(43) Pub. Date: Apr. 18, 2024

(54) PANEL MOUNTING BRACKET WITH QUICK RELEASE CLIP AND RELATED METHODS

(71) Applicant: Kevin Stapleton, New Braunsfels, TX (US)

(72) Inventor: Kevin Stapleton, New Braunsfels, TX (US)

(21) Appl. No.: 18/488,256

(22) Filed: Oct. 17, 2023

Related U.S. Application Data
(60) Provisional application No. 63/379,787, filed on Oct. 17, 2022.

(51) Int. Cl. H02S 30/10; F16M 13/02; H02S 20/23

(52) U.S. Cl. CPC H02S 30/10; F16M 13/02; H02S 20/23

(57) ABSTRACT

A device is provided for mounting solar panels to a structure and may include a base to be positioned on the structure, at least one first extension having a proximal end coupled to the base and a distal end spaced apart from the base, and a panel mounting platform coupled to the distal end of the at least one extension. The panel mounting platform may have opposing first and second ends with a first tab at the first end and a second tab at the second end configured to engage inner portions of first and second solar panel frames, respectively. The device may further include a second extension having a proximal end coupled to the panel mounting platform, and a distal end spaced apart from the proximal end, the second extension having a third tab configured to engage an outer portion of the second solar panel frame.

### RELATED APPLICATIONS

This application claims the benefit of U.S. provisional application Ser. No. 63/379,787 filed Oct. 17, 2022, which is hereby incorporated herein in its entirety by reference.

### TECHNICAL FIELD

The present disclosure generally relates to mounting fixtures, and, more particularly, to mounting fixtures for rooftop panel installations, such as for solar panels, for example.

### BACKGROUND

Solar panels, such as photovoltaic (PV) and solar water heating panels, are frequently used to take advantage of electrical power generation and heating properties of sunlight. To provide space savings and potentially enhanced efficiency, solar panels are in many cases installed on rooftops of buildings (e.g., office buildings, houses, pavilions, free-standing structures with or without walls, etc.). However, because of winds and storms, the mounting fixtures used for installing solar panels on buildings need to be sufficiently strong and durable to reduce the chances of damage or injury from a panel coming loose during a storm, etc.

Various mounting fixtures have been developed for solar panel installation. For example, one particularly advantageous system for mounting a solar panel(s) on a building is disclosed in U.S. Pat. No. 9,628,018 to Stapleton, which is hereby incorporated herein in its entirety by reference. The system may include a plurality of panel mounting brackets each including a base to be positioned on the building, and a vertical extension having a proximal end coupled to the base and a distal end vertically spaced apart from the base, with the distal end defining a fastener channel therein. The system may also include a plurality of mounting clamps each including a bottom flange, and a top flange spaced apart from the bottom flange and partially overhanging the bottom flange and defining a slot therebetween to receive a lip of the solar panel. An end extension may couple respective ends of the bottom flange and top flange together, and a fastener channel connector may be coupled to the bottom flange and configured to be slidably received within the fastener channel. Other solar panel mounting fixtures and systems are disclosed in U.S. Pat. Nos. 9,484,853; 9,397,605; 9,145,685; and 9,057,545, also to Stapleton, all of which are hereby incorporated herein in their entireties by reference.

Despite the existence of such mounting fixtures, further enhancements may be desirable in some applications to help simplify and expedite the installation of solar panels on buildings or rooftops.

### SUMMARY

A device is provided for mounting solar panels to a structure, each solar panel including a frame. The device may include a base to be positioned on the structure, at least one first extension having a proximal end coupled to the base and a distal end spaced apart from the base, and a panel mounting platform coupled to the distal end of the at least one extension. The panel mounting platform may have opposing first and second ends with a first tab at the first end and a second tab at the second end configured to engage inner portions of first and second solar panel frames, respectively. The device may further include a second extension having a proximal end coupled to the panel mounting platform, and a distal end spaced apart from the proximal end, the second extension having a third tab configured to engage an outer portion of the second solar panel frame.

In an example implementation, the first and second tabs face inward towards the second extension. In some embodiments, the second solar panel frame may have a channel on an exterior thereof, and the third tab may be configured to engage the channel of the second solar panel frame. In one implementation, the device may further include a third extension spaced apart from the second extension, with the third extension having a proximal end coupled to the panel mounting platform and a distal end spaced apart from the proximal end, and the third extension having a fourth tab configured to engage the first solar panel frame.

In an example embodiment, the panel mounting platform may comprise first and second overlapping sections. In an example configuration, the third tab may be at the distal end of the second extension. In some embodiments, the base and at least one first extension may be integrally formed as a first unitary body, and the panel mounting platform and the second extension may be integrally formed as a second unitary body removably attachable to the first unitary body. In an example implementation, the distal end of the at least one first extension may have a fastener channel therein, and the device may further include a fastener carried within the fastener channel and configured to couple the panel mounting platform to the at least one first extension. In one example embodiment, the base, at least one first extension, the panel mounting platform, and second extension may be integrally formed as a unitary body. First and second set screws may be carried by the panel mounting platform for engaging the first and second solar panel frames, respectively, in some configurations. Also, in some example configurations, the at least one first extension may comprise a plurality thereof spaced apart along the base.

A related method for mounting a plurality of solar panels to a structure is also provided. The method may include coupling a panel mounting bracket to the structure, with each panel mounting bracket comprising a base positioned on the structure, and at least one first extension having a proximal end coupled to the base and a distal end spaced apart from the base. The method may further include coupling a mounting clamp to the frame of a first solar panel, with the mounting clamp comprising a panel mounting platform having opposing first and second ends and further comprising a first tab at the first end and a second tab at the second end engaging an inner portion the first solar panel frame, and a second extension having a proximal end coupled to the panel mounting platform, and a distal end spaced apart from the proximal end, the second extension having a third tab engaging an outer portion of the second solar panel frame. The method may also include coupling the panel mounting platform to the distal end of the at least one extension, and coupling a second solar panel to the mounting clamp with the first tab engaging an inner portion of a second solar panel frame.

### BRIEF DESCRIPTION OF THE DRAWINGS

FIG. 1 is an end view of a panel mounting bracket in accordance with an exemplary embodiment of the invention including an under-mounting clamp.

FIG. 2 is a top view of the mounting bracket of FIG. 1 with mounting holes for securing the bracket to a structure.

FIG. 3 is a side view of the mounting bracket with a single mounting clamp for attaching to the exterior sides of panels located at the perimeter of a panel array.

FIG. 4 is a side view of a mounting bracket attached to the frame of the underside of a panel at the perimeter of a panel array.

FIG. 5 is a side view of a mounting bracket with two mounting clamps for attaching to respective frames of two adjacent modules.

FIG. 6 is an end view of a mounting bracket with two mounting clamps respectively connected to two adjacent modules.

FIG. 7 is a three-dimensional perspective view of a pair of mounting brackets as shown in FIG. 4 each having a respective mounting clamp coupled to a same panel.

FIG. 8 is a top view of two panels as they would appear installed on a rooftop using a plurality of the bracket assemblies illustrated in FIGS. 4 and 6.

FIG. 9 is a perspective view of another solar panel mounting clamp in accordance with an example embodiment.

FIG. 10 is a perspective view of the mounting clamp of FIG. 9 installed on a mounting bracket of FIG. 1 in an example implementation.

FIG. 11 is a perspective view of the mounting bracket and clamp combination of FIG. 10 with an attached solar panel in an example implementation.

FIG. 12 is a perspective view illustrating the mounting clamp and bracket combination of FIG. 11 after installation on a rooftop with two solar panels attached thereto.

FIG. 13 is a perspective view of an example mounting bracket with integrated mounting clamp in accordance with an example embodiment.

FIG. 14 is a perspective view of the mounting bracket with integrated mounting clamp of FIG. 13 with a solar panel attached thereto in an example embodiment.

FIG. 15 is an interior view from inside the solar panel of FIG. 14 illustrating connection of a tab of the mounting clamp to the inside of the solar panel frame.

FIG. 16 is a perspective view of an alternative embodiment of the mounting bracket with integrated mounting clamp of FIG. 13 configured for attachment to a different style of solar panel in an example implementation.

FIG. 17 is a perspective view of an alternative embodiment of the mounting bracket with integrated mounting clamp of FIG. 13 in accordance with another example embodiment.

FIG. 18 is a side view of another mounting clamp in accordance with an example embodiment.

FIG. 19 is a perspective view of the mounting clamp of FIG. 18 installed on a mounting bracket of FIG. 1 in an example implementation.

FIG. 20 is a perspective view illustrating the mounting clamp and bracket combination of FIG. 19 after installation on a rooftop with two solar panels attached thereto.

### DETAILED DESCRIPTION

The present description is made with reference to the accompanying drawings, in which exemplary embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used throughout to indicate like elements in different embodiments.

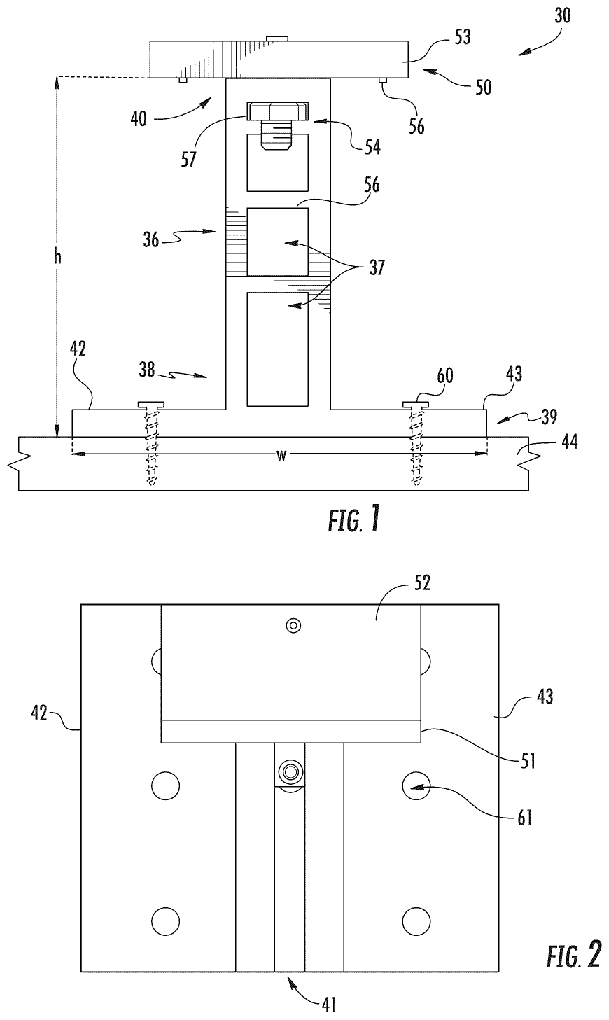

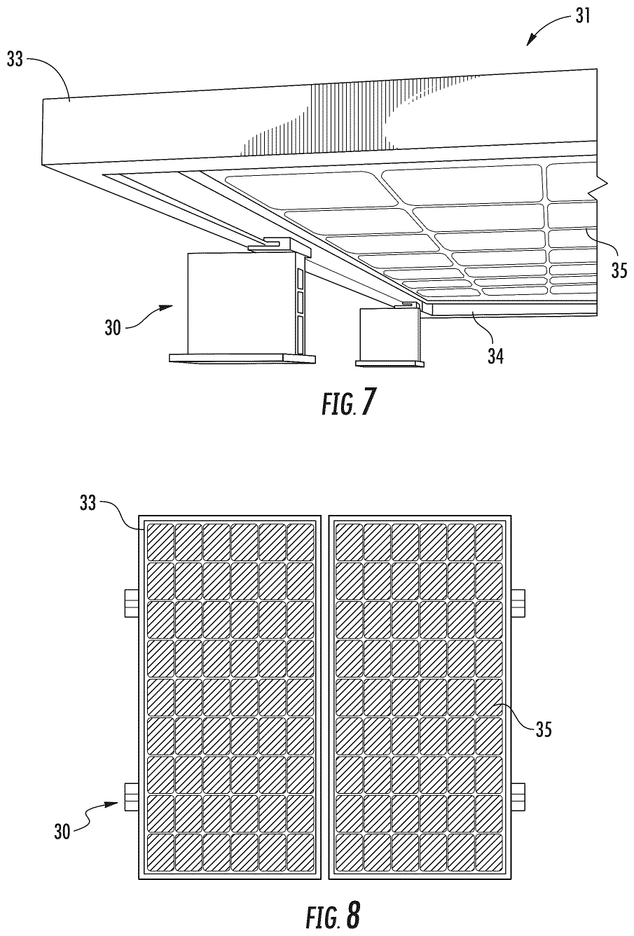

Referring initially to FIGS. 1-8, an assembly 30 for mounting one or more solar panels 31 on a building (e.g., on a roof) is first described. The assembly 30 illustratively includes a mounting bracket 32 (which is also referred to as a “foot” herein) for installing solar panels or modules 31. By way of background, solar modules or panels are typically mounted to racking using clamps that grip the module and hold it tight to rails which are mounted to rooftops by “L” shaped feet. The foot 32 illustrated in FIG. 1 advantageously avoids the need for such rails and clamps by mounting panels to roofs through the use of multiple feet (e.g., four feet, although other numbers of feet may be used), which are attached to the underside of each panel. More particularly, each panel 31 may include an outer frame 33 defining a lip 34 on the underside thereof, and in the example embodiment illustrated in FIGS. 7 and 8 the outer frame carries a photovoltaic cell array 35 therein (although the assembly 30 may also be used for mounting solar hot water heating panels as well, for example).

In the illustrated example, the foot 32 has a generally rectangular-shaped central vertical extension portion 36 with one or more hollow central area(s) or channel(s) 37 therethrough. A proximal end 38 of the vertical extension 36 is coupled to a flange or base 39 of the foot 32, and a distal end 40 of the vertical extension is vertically spaced apart from the proximal end, as seen in FIG. 1. An upper fastener channel slot or groove 41 is defined in the distal end 40 (see FIG. 2), though grooves may instead or in addition be provided on either or both sides of the vertical extension 36 in some embodiments, if desired. The foot 32 has a height h and a width w, which in an example embodiment may both be three inches, but other dimensions may also be used in different embodiments.

The base 39 illustratively includes two side extensions 42, 43 that extend outwardly away from the vertical extension 36 so that the vertical extension is centered on the base (although it need not be centered in all embodiments). Thus, when the bottom surface of the base 39 sits flat on a rooftop or roof deck 44 upon installation, the vertical extension 36 points upward or normal to the surface of the roof (although the vertical extension may form different angles with respect to the base besides 90° in different embodiments). Serrations or other surface features may optionally be included on portions of the upper surface of the distal end 40 and/or the bottom surface of the base 39, if desired. The serrations may advantageously provide for improved electrical grounding with the frame of the panel, as well as increased grip or friction, for example, as will be appreciated by those skilled in the art.

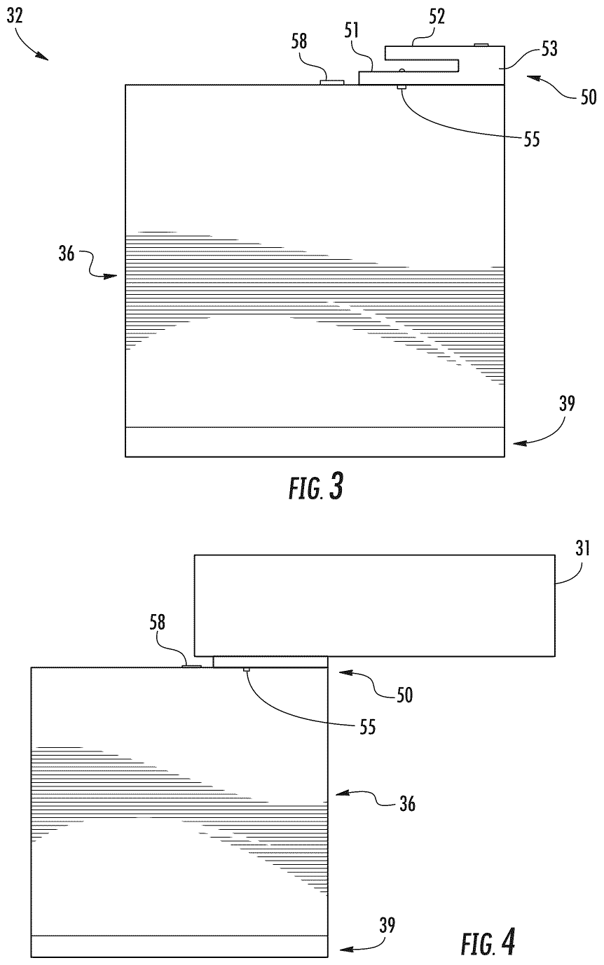

In the illustrated example, the feet 32 are attached to the underside lip 34 of each panel frame 33, as shown in FIGS. 4 and 7. While still on the ground, the installation technician may advantageously attach the feet 32 to the bottom of each panel on their longer sides (e.g., top and bottom sides) with the front edge of the foot facing out from the panel using an under-mounting clamp 50. However, the feet 32 may be attached to the other sides of the panels 31 as well in some embodiments, and the panels may also be attached to the feet after the feet have been installed on the rooftop 44, if desired.

The mounting clamp 50 illustratively includes a bottom flange 51, a top flange 52 spaced apart from the bottom flange and partially overhanging the bottom flange (see FIG. 3) to define a slot therebetween, and an end extension 53 coupling respective ends of the bottom flange and top flange together. The slot is configured to engage or receive the lip 34 of the solar panel 31 on the outside edges of the solar panels at the end of each row of panels, as seen in FIG. 7. The mounting clamp 50 further illustratively includes a fastener channel connector 54 coupled to the bottom flange 51 and configured to be slidably received within the fastener channel 41.

In the present example, the fastener channel connector 54 illustratively includes a T-shaped connector or slide bar coupled to the bottom flange 51 on a side thereof opposite the top flange 52 (i.e., on its bottom side). The T-shaped connector 57 is configured to be slidably received within the fastener channel 41, as seen in FIGS. 1 and 2. The fastener channel connector 54 may first be attached to the solar panel 31, and then the feet 32 connected to respective mounting clamps 50. Another approach is that the mounting clamps 50 may be coupled to respective feet 32, and the entire assembly 30 (i.e., mounting clamp plus foot) may then be connected to the solar panel 31. The mounting clamp 50 further illustratively includes a retaining set screw(s) 55 which may be tightened to secure the lip 34 within the slot between the bottom and top flanges 51, 52, and a slide bar retaining bolt 58 and a corresponding nut 59. The set screws 55 may also advantageously facilitate an electrical grounding connection with the foot 32, as will be discussed further below.

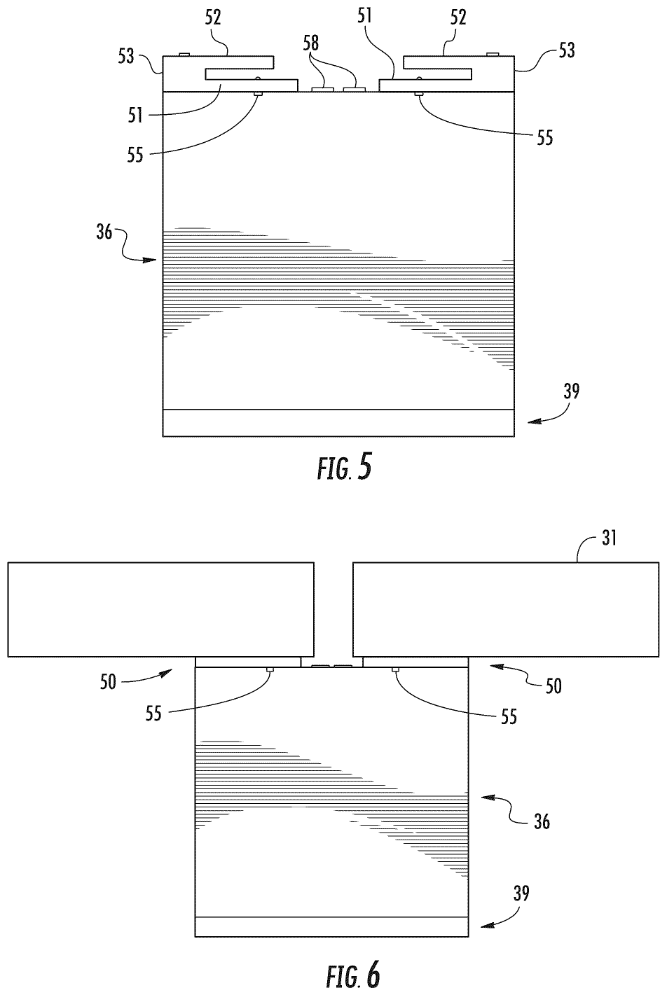

A first column of panels 31 may then be attached on the roof 44 with deck screws 60 through mounting holes 61 in the side extensions 42, 43 on the outward or perimeter side of the array, typically in a straight line. In some instances, a sealant may be used under each foot 32, if desired. Various types of sealants may be used, such as caulking, tar, Butyl tape, etc. An adjacent column of solar panels 31 may then be attached with additional feet 32 adjacent to the first column of solar panels so as to share the second set of feet (see FIGS. 5 and 6) between them. That is, the fastener channel 41 of each vertical extension portion may be of sufficient dimensions or length to slidably receive two (or more) fastener channel connectors 54 therein. While the feet 32 are shared between adjacent panels, the mounting clamps 50 retain each solar panel 31 independently. This allows each solar panel 31 to be installed and secured individually, and in the event that a solar panel is to be removed from an array, this can be done independently without loosening the adjacent solar panel, which is generally not possible with typical panel or panel mounting arrangements.

The installation process may be repeated for each column of solar panels 31 to be installed, until the last column of solar panels is reached. On the outer perimeter of the last solar panel 31, one mounting clamp 50 may be used per foot 32 to attach to the outer edge of each of the perimeter solar panels (see, e.g., FIGS. 4 and 7).

A significant advantage of the assembly 30 is that it may advantageously be connected or coupled to a respective solar panel 31 on the ground, rather than having to be coupled to the solar panel on the roof 44 where this is more difficult (and potentially more dangerous), and where it is much harder to recover dropped tools, screws, nuts, washers, or other parts. Moreover, this may also help expedite the installation process.

The hollow channels or passageways 37 in the vertical extension 36 may serve as wire management channels, which may be used for keeping electrical transmission wires (e.g., for PV panels) or temperature sensor wires (e.g., for a water heater panels) secured in place. However, the cross-support members 56 which define the channels 37 need not be included in all embodiments, although even when the channels are not used for routing wires the cross-support members may provide added rigidity and/or stability to the feet 32. It should also be noted that the vertical extension 36 of the foot 32 need not be hollow in all embodiments, and that different shapes beside a rectangular shape may also be used for the base 39 and/or the vertical extension in some embodiments. One example material for the foot 32 and the mounting clamp 50 is aluminum, which may be extruded into the desired shape, although other suitable materials may also be used in different embodiments. The various screws and fasteners described herein may be stainless steel, brass, galvanized steel, etc.

Here again, a sealant may optionally be used under each foot 32 so that the screws 60 are screwed through the foot 32 and sealant into the roof or decking 44 at desired locations. By way of example, two or more feet 32 may be secured to the roof 44 to receive one side of the panel, i.e., two (or more) feet are used on each of the top and bottom sides or edges of the solar panel 31, as shown in FIG. 7, although in some embodiments a single foot may be used.

It should be noted that the above-described mounting assembly 30 may be used with a variety of roof types, including flat and sloped roofs, and over different types of roof coverings (e.g., shingles, tiles, panels, etc.). Moreover, the mounting feet may be used for installations other than on rooftops, such as where mounting to the side of a building or other structure is required.

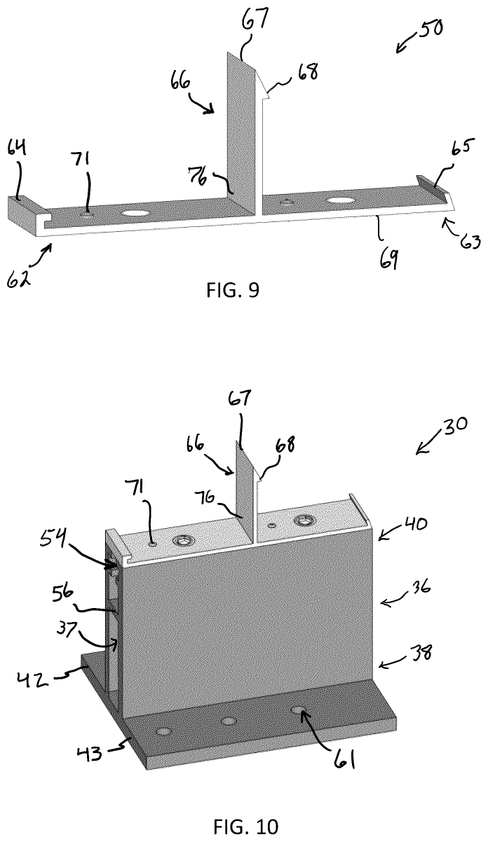

Turning to FIGS. 9-12, another example clamp 50 which may be used with the mounting bracket 32 is now described. Generally speaking, the clamp 50 is an interior mounting clamp in that it may be used between two adjacent solar panels 31 to couple them both to the same mounting bracket 32 (similar to the configuration shown in FIG. 6), although it may also be used as an end clamp when connected to the outer edge of panels on the periphery of a panel array (see FIG. 4). Further details on panel mounting brackets or “feet” with which the clamp 50 may be used are set forth in U.S. Pat. Nos. 9,145,685; 11,146,207; 9,057,545; and 10,630,229, also to the present Applicant and which are all hereby incorporated herein in their entireties by reference.

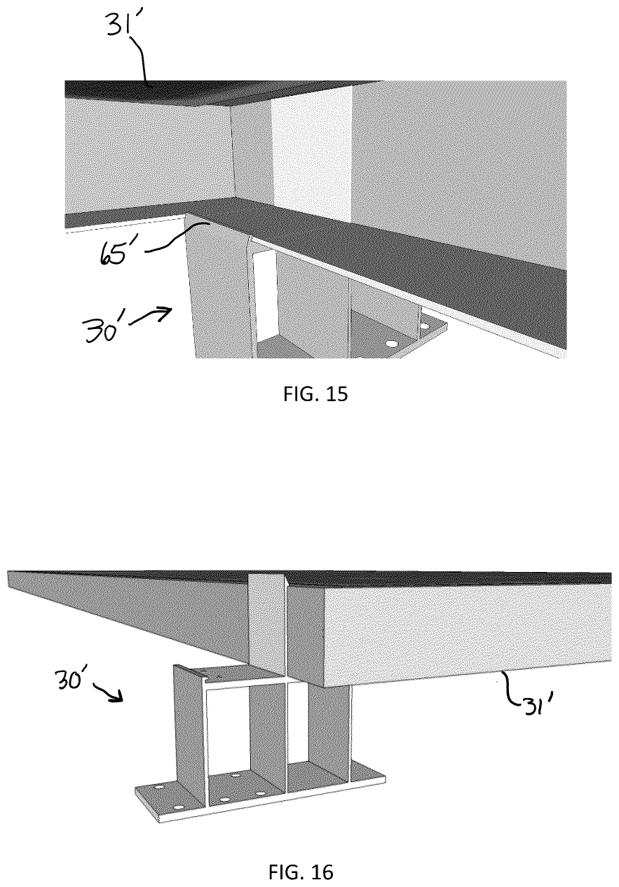

The clamp 50 enables solar panels 31 to be installed on rooftops or other structures (e.g., walls, ground-based mounting frames, etc.) without the use of traditional mid-clamps and hardware (see FIG. 1). The clamp 50 illustratively includes a panel mounting platform 69 coupled to the distal end 40 of the vertical extension 36. More particularly, the panel mounting platform 69 includes opposing first and second ends 62, 63 respectively having first and second tabs 64, 65 to engage inner portions or undersides of respective solar panel 31 frames (see FIG. 15). A vertical extension 66 has a proximal end 76 coupled to the panel mounting platform 69, and a distal end 67 spaced apart from the proximal end. The extension 66 has another tab 68 configured to engage the exterior of a solar panel 31 frame which functions as a “quick clip” to engage the solar panel and hold it in place.

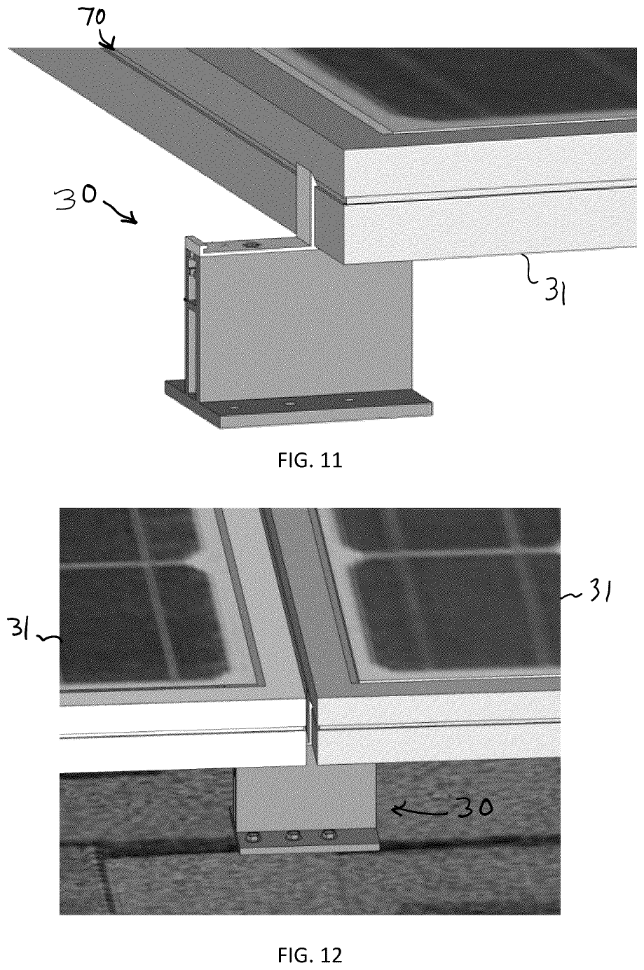

In the example illustrated in FIG. 11, the solar panel 31 frame has a groove or channel 70 on the exterior thereof, and the tab 68 is configured to engage with the channel. This configuration advantageously enables an installer to install the mounting bracket 32 onto the solar panels 31 from the safety of the ground before lifting them to and installing them on the roof (or other structure). This not only saves installation time, but also the amount of hardware and the number of tools required on the rooftop, which may also lead to increased safety for installers. After the modules are installed on the roof, individual modules can be removed for maintenance by simply prying the tab 68 away from the solar panel 31, and lifting the solar panel without interfering with adjacent panels. The extension 66 provide a spring bias to keep the tab 68 engaged with the groove 70 and hold the solar panel 31 in place.

After installing the solar panel 31 shown in FIG. 11, a next solar panel may be positioned on the panel mounting platform 69 and its frame is slid into the tab 64 opposite the first panel, as shown in FIG. 12. The opposite edge of the next solar panel 31 is then attached to the roof 44 with mounting brackets 32 that have likewise been clipped on the panel's opposite frame prior to being lifted to the roof. With solar panels 31 engaged into the clamp 50, they rest on two sharp cone point set screws 71 which byte into the frames of the solar panels 31, providing electrical ground bonding in accordance with UL 2703, for example (although set screws need not be used in all embodiments).

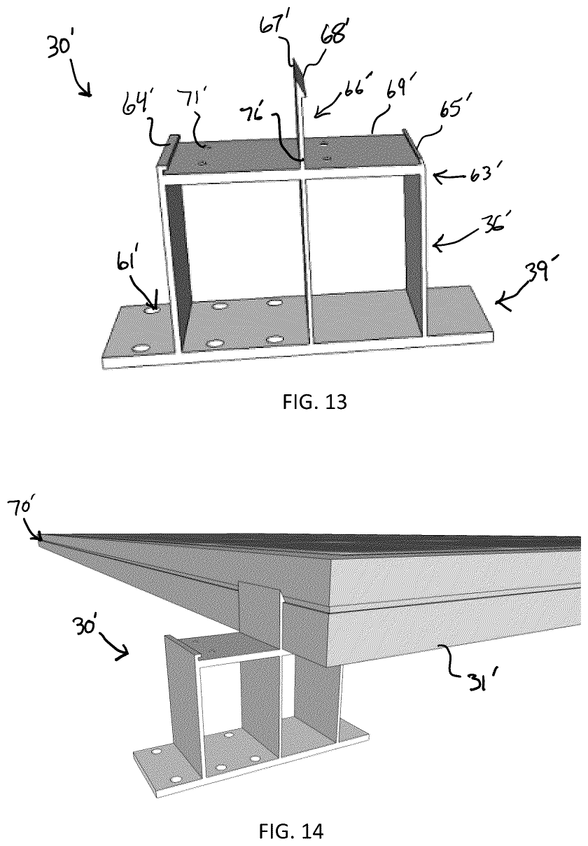

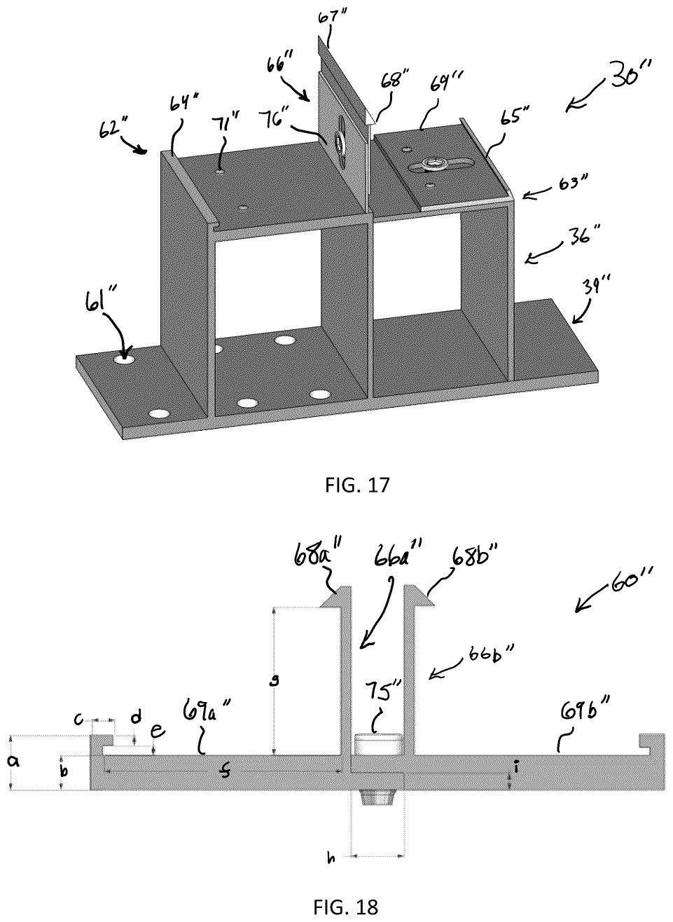

Additionally, the quick clip design can be integrated into a mounting assembly 30′ that is a single unitary body, as shown in FIGS. 13-15. That is, in the previously described embodiment, the mounting bracket 32 is formed as a single unitary body, and the clamp 50 is formed as a separate, single unitary body. In the present embodiment, the bracket and clamp portions are formed together (e.g., as an aluminum extrusion) into a single, unitary body defining the mounting assembly 30′. In the illustrated embodiment, the bracket portion includes a base 39′ with mounting holes 61′, and three spaced apart vertical extensions 36′. In an alternative configuration shown in FIG. 16, the extension 66′ and tab 68′ of the integrated clip design may be formed in such a way that it works with generic solar panels 31′ (i.e., that do not have the exterior groove 70) by clamping to the top outer edge of the solar panel frame. In still another example embodiment, the vertical portion of the extension 66′ may be made adjustable along with the horizontal panel mounting platform 69′ upon which the first frame side sets in order to adjust to various frame dimensions, as shown in FIG. 17. More particularly, the extension 66′ and platform 69′ have groves or slots therein allowing the pieces to move vertically or horizontally, respectively, to the desired positioned and then secured in place with a nut/bolt in the slot as shown. Other suitable approaches for adjusting the height or width of the clamp portion may also be used.

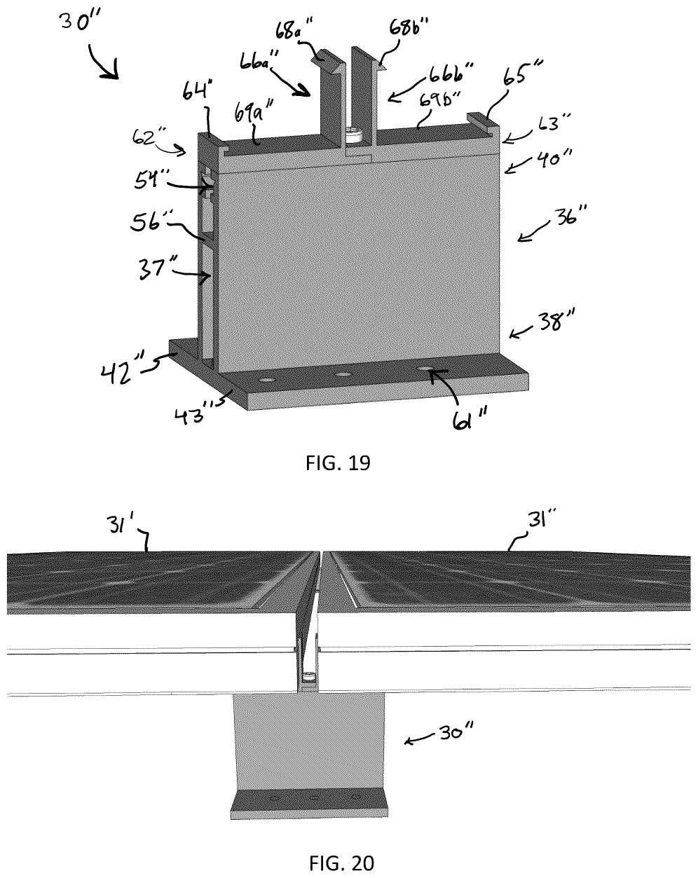

Turning now to FIGS. 18-20, still another alternative embodiment of a clamp 50″ is provided in which two extensions 66a″ and 66h″ are connected to respective overlapping portions 69a″, 69h″ of the panel mounting platform. That is, the different sections of the clamp may be connected to respective panels 31″ separately, and then when the pieces are positioned on the mounting bracket 32″ the portions 69a″, 69h″ overlap to form the panel mounting platform, and are connected together by a fastener 75″, e.g., a bolt that connects with a nut in the fastener channel 54″. This design not only has the advantage of spring biased locking tabs on both sides of each solar panel 31″, but it also allows a given panel to be easily removed from the assembly without having to remove other panels, as will be appreciated by those skilled in the art. For the implementation shown in FIG. 18, example dimensions may be as follows:
a=9.525 mm; b=6.35 mm; c=3.175 mm; d=1.27 mm; e=3 mm; f=25.5 mm; g=22.62 mm; h=10 mm; and i=3.175 mm. However, these dimensions are merely provided by way of example, and different dimensions may be used in different embodiments.

It should be noted that the clamps 60 and 60″ may also be used with a variety of different mounting brackets or assemblies, and not just the mounting brackets 32, 32″. Moreover, it should be noted that features shown in some embodiments may be used in others. For example, any of the panel mounting platforms may be a single piece or include two overlapping sections, the extensions 66 and 66″ may have a vertically adjustable height like the extension 66′, and the panel mounting platform of the clamp 50″ could be a single unitary piece as with the clamp 50 (as opposed to overlapping sections), etc.

Many modifications and other embodiments of the invention will come to the mind of one skilled in the art having the benefit of the teachings presented in the foregoing descriptions and the associated drawings, which are provided by way of example. Therefore, it is understood that the disclosure is not to be limited to the specific embodiments disclosed, and that other modifications and embodiments are intended to be included within the scope of the appended claims.

That which is claimed is:

1. A device for mounting solar panels to a structure, each solar panel comprising a frame, the device comprising:
a base to be positioned on the structure;
at least one first extension having a proximal end coupled to the base and a distal end spaced apart from the base;
a panel mounting platform coupled to the distal end of the at least one extension, the panel mounting platform having opposing first and second ends with a first tab at the first end and a second tab at the second end configured to engage inner portions of first and second solar panel frames, respectively; and
a second extension having a proximal end coupled to the panel mounting platform, and a distal end spaced apart from the proximal end, the second extension having a third tab configured to engage an outer portion of the second solar panel frame.

2. The device of claim 1 wherein the first and second tabs face inward towards the second extension.

3. The device of claim 1 wherein the second solar panel frame has a channel on an exterior thereof, and wherein the third tab is configured to engage the channel of the second solar panel frame.

4. The device of claim 1 further comprising a third extension spaced apart from the second extension, the third extension having a proximal end coupled to the panel mounting platform and a distal end spaced apart from the proximal end, the third extension having a fourth tab configured to engage the first solar panel frame.

5. The device of claim 1 wherein the panel mounting platform comprises first and second overlapping sections.

6. The device of claim 1 wherein the third tab is at the distal end of the second extension.

7. The device of claim 1 wherein the base and at least one first extension are integrally formed as a first unitary body, and the panel mounting platform and the second extension are integrally formed as a second unitary body removably attachable to the first unitary body.

8. The device of claim 1 wherein the distal end of the at least one first extension has a fastener channel therein, and further comprising a fastener carried within the fastener channel and configured to couple the panel mounting platform to the at least one first extension.

9. The device of claim 1 wherein the base, at least one first extension, the panel mounting platform, and the second extension are integrally formed as a unitary body.

10. The device of claim 1 further comprising first and second set screws carried by the panel mounting platform for engaging the first and second solar panel frames, respectively.

11. The device of claim 1 wherein the at least one first extension comprises a plurality thereof spaced apart along the base.

12. A device for mounting solar panels to a mounting bracket positioned on a structure, the device comprising:
a panel mounting platform to be coupled to the mounting bracket, the panel mounting platform having opposing first and second ends with a first tab at the first end and a second tab at the second end configured to engage inner portions of first and second solar panel frames, respectively; and
a second extension having a proximal end coupled to the panel mounting platform, and a distal end spaced apart from the proximal end, the second extension having a third tab configured to engage an outer portion of the second solar panel frame.

13. The device of claim 12 wherein the first and second tabs face inward towards the second extension.

14. The device of claim 12 wherein the second solar panel frame has a channel on an exterior thereof, and wherein the third tab is configured to engage the channel of the second solar panel frame.

15. The device of claim 12 further comprising a third extension spaced apart from the second extension, the third extension having a proximal end coupled to the panel mounting platform and a distal end spaced apart from the proximal end, the third extension having a fourth tab configured to engage the first solar panel frame.

16. The device of claim 12 wherein the panel mounting platform comprises first and second overlapping sections.

17. The device of claim 12 wherein the at least one first extension comprises a plurality thereof spaced apart along the base.

18. A method for mounting a plurality of solar panels to a structure, each solar panel comprising a frame, the method comprising:
coupling a panel mounting bracket to the structure, each panel mounting bracket comprising a base positioned on the structure, and at least one first extension having a proximal end coupled to the base and a distal end spaced apart from the base;
coupling a mounting clamp to the frame of a first solar panel, the mounting clamp comprising a panel mounting platform having opposing first and second ends with a first tab at the first end and a second tab at the second end engaging an inner portion the first solar panel frame, a second extension having a proximal end coupled to the panel mounting platform, and a distal end spaced apart from the proximal end, the second extension having a third tab engaging an outer portion of the second solar panel frame;
coupling the panel mounting platform to the distal end of the at least one extension; and
coupling a second solar panel to the mounting clamp with the first tab engaging an inner portion of a second solar panel frame.

19. The method of claim 18 wherein the second solar panel frame has a channel on an exterior thereof, and wherein the third tab is configured to engage the channel of the second solar panel frame.

20. The method of claim 18 where the mounting clamp further comprises a third extension spaced apart from the second extension, the third extension having a proximal end coupled to the panel mounting platform and a distal end spaced apart from the proximal end, the third extension having a fourth tab engaging the first solar panel frame.
